(19) United States
(12) Patent Application Publication
(10) Pub. No.: US 2011/0030652 A1
(43) Pub. Date: Feb. 10, 2011

(54) Inertial Rotation Internal Combustion Engine

(76) Inventor: Robert Kirk Spencer, SR., Detroit, MI (US)

Correspondence Address: ROBERT KIRK SPENCER, SR., 18483 Rutherford, Detroit, MI, 48235, US

(21) Appl. No.: 12/538,078

(22) Filed: Aug. 7, 2009

(51) Int. Cl. F02B 53/00

(52) U.S. Cl. 123/245

(57) ABSTRACT

This invention called the IRICE uses rotational pistons (cystons). The IRICE is more efficient than a conventional piston engine by negating loses caused by reversal of the pistons in the engine bore. The IRICE contains two or more adjacent cystons with at least one head per cyston separating chambers contained in the housing between adjacent cyston heads. Cystons alternate their motions via a fluid or gas, called the pf, under pressure in relation to the pressure in adjacent chambers. The cyston(s) currently in motion, called the MOP cyston(s), contacts part of the IRICE, called the pushcan, producing torque. The cyston(s) static in relation to MOP(s) are called the SIP cyston(s). SIP's contacts a section of the IRICE called the clampcan that restricts it's motion allowing pf pressure in the chamber between the two aforementioned cyston's heads to exhort force moving the MOP cyston(s) and the pushcan to do work. Pf is moved through the IRICE chambers via inlets and outlets.

The Internal Rotation Inertial Combustion Engine, here on referred to as the IRICE, uses rotational pistons, here forth referred to as a cystons, to achieve torque while expending the kinetic energy of the moving cyston(s) to more efficiently preform the compression and exhaust stages of a conventional four stroke piston engine. The IRICE consist of two or more adjacent cystons, each symmetric around their aligned centers of gravity, contained within the housing, which alternate their motions to produce work. The IRICE is more efficient than a conventional piston engine by negating loses caused by reciprocation of the pistons.

The IRICE contains two or more adjacent cystons with at least one head per cyston. These heads create chambers by separating a continuous volume, like a toroid, contained with in the housing. Cystons alternate their motions via a powering force, called the pf, with in at least one chamber, the powering chamber(s), causing the heads that form said chamber to move away from one another. At any time at least one head is static in relation to the other, the SIP cyston, and exhorting it's force against a part of housing called the clampcan, which may be mounted to the housing. The other cyston that forms the powering chamber will therefore be in motion in relation to the SIP cyston and is the MOP cyston. The MOP cyston exhorts it's force against the pushcan. It is the pushcan where torque is created to preform the work output. Pf, both used and unused, is moved through chambers via inlets and outlets respectfully.

The major parts of the IRICE engine, shown in FIG. 2, can be manufactured from a host of different materials (ie. metals, polymers) as long as these materials are of sufficient strength to not fail during operation of the IRICE. The materials should be of sufficient strength to resist ware as this would lead to pf seepage. It should also be machined to tolerances that allow the cystons to align up properly at the appropriate time and placement as to allow the cyston heads to properly line up with the appropriate inlet and outlet when needed.

### FIELD OF THE INVENTION

The field of this invention includes any application where torque or current is desired. It is the wide range in engine sizing that makes this engine design near limitless in it's application. Although the inventor seeks to file this invention under field of combustion engines, he is well aware of the potential for retro-fitting this design to function as either a pneumatic drive, a pump, an electric motor or power generator or combination of all.

### BACKGROUND OF THE INVENTION

Throughout written history, man has used power in the form of torque to do work. The application of such work has gone through revolutionary improvements with in the last few hundred years. It has gone from being powered by animal input, which was the case since it's infancy, to being produced by fossil fuels and nuclear power in the last hundred years or so. Although these later forms of power produce greater output, these application have generated worries to mankind in the form of environmental concerns. This invention hopes to help in these concerns by decreasing consumption by increasing efficiency over the conventional piston driven engines that exist today.

The origin of the invention began when the question was posted to the inventor, ‘How can the inefficiency of the conventional internal combustion engine be improved through the elimination of piston reciprocation?’. It was the quest to come up with a better kind of engine that lead to this invention. The IRICE's main improvement over other patented rotary engines is in it compression ratio. It is through these higher compression ratios that the inventor hopes that this invention can some day run off of low octane fuels, diesel, bio-fuels and/or even alcohols.

One of the problems with the Wankel rotary engine deals with the sealing off of adjacent combustion chambers with in the engine housing. Patents have been issued in the past to improve upon the original engine patent by addressing this seal issue. This invention improves upon the Wankel engine by better separating the combustion chambers with in the engine housing while offering a mechanism that can be distinctively different from the patent issued to Wankel over a half century ago. The inventor claims separation from all Wankel patents issued because discovery of the Wankel patent came post concert of the cyston design & the inventor believes the difference in the two designs is obvious.

It was later in the conception of the IRICE that methods of powering this style of engine was broadened to include such methods as steam and electromagnetic flux. The concept of a two cyston two headed style was also found to be to limiting to the multiple applications that this engine style can be utilized to preform. Therefore, previously envisioned claims were eliminated and others were built upon to produce this patent that exist now.

### SUMMARY OF THE INVENTION

In brief the IRICE is simply cyclic piston rotary engine that is more efficient than conventional internal combustion engines.

### BRIEF DESCRIPTION OF THE DRAWING

FIG. 1 shows a front view of the IRICE engine with the front housing cut away to show the cystons, 1 set of cyston heads and the grips for those heads.

FIG. 2 is an exploded view of the IRICE with the major parts labeled.

FIG. 3 thru FIG. 7 are wireframe frontal views of the IRICE at different points during a full combustion cycle. This combustion cycle completes after all chambers have fired once and gone through the 4 stages of being a powering, exhaust, spent & intake chamber. This is repeated throughout the use of the IRICE as these chambers move around within the housing.

### DETAILED DESCRIPTION OF THE DRAWING

The IRICE shown in the drawing is an example of a 2 cyston IRICE with 2 heads per cyston, 18 head-triggered valued inlets & outlets, a mounted outside clampcan and inner pushcan with ratcheted contact-triggered MOP & SIP grips. This particular representation of the IRICE is an equivalent of a gasoline 4-stoke engine but does not aim to limit the claims of this patent to either 4-stoke engines, gasoline as a pf or engines as opposed to generators. It is simply for the purposes of IRICE mechanics explanation.

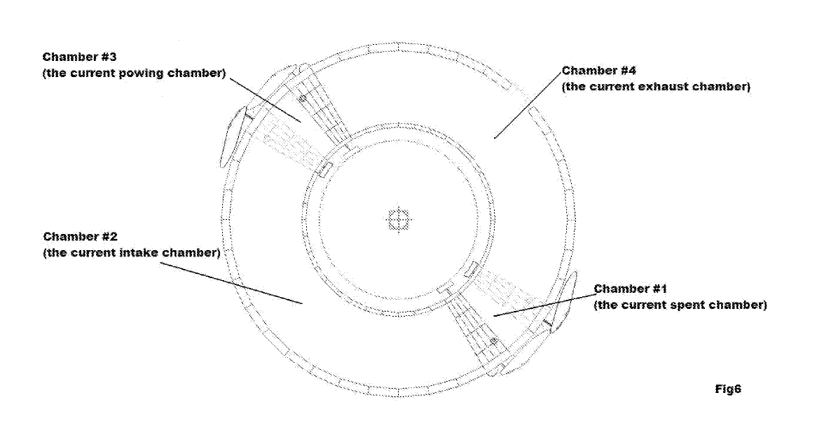

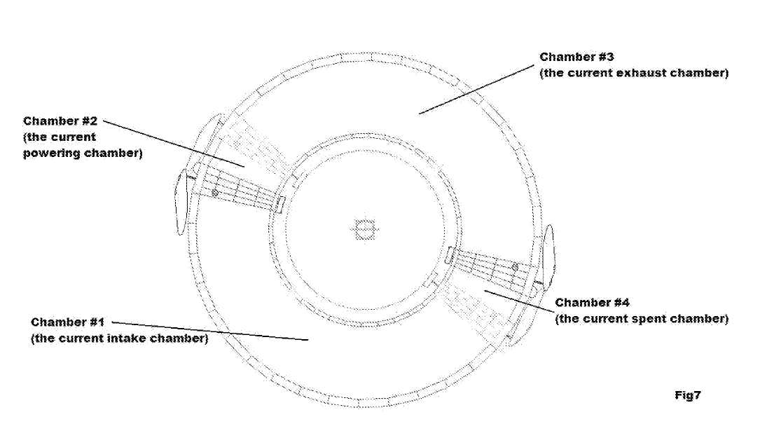

It is also worth noting that all angle measurements within this description zero at the top of referenced images (12 o'clock) and sweep in a clockwise direction. An additional point of interest is that although the chambers mentioned change in both volume & position on the drawings, they do not change in their order. In FIG. 3 from the 12o'clock position going clockwise are chambers #1, #2, #3 & #4. Chamber2 will always be clockwise next after chamber1, and so on, despite their current position.

In FIG. 3 at the top of the drawing notice the contained chamber (chamber1) at the 12c′clock position between cyston1's & cyston2's #1 heads. This chamber is filled with fuel mixture (pf) under compression (the current powering chamber). Directly across the center of the IRICE from there, between both cystons' #2 heads, is chamber3 (the current spent chamber) filled with the remnants of burnt fuel that was not expelled due to the geometry of the IRICE. Along the right side of FIG. 3 (centered at 3o'clock) is chamber2 (the current exhaust chamber) filled with the unexhausted spent pf that will be expelled from the chamber by cyston 1's #1 head. Across the center from chamber2 is chamber4 (the current intake chamber), filled with fresh pf which will be compressed by cyston1's #2 head when chamber1 fires & puts cyston1 in motion.

In FIG. 4 cyston1 is in motion and has traveled only 30°. While this is happening cyston2's #2 head vents exhaust out of chamber2 through outlets on the housing's back side and it allows fresh pf to enter into chamber3 through inlets on the housing front side.

In FIG. 5 the IRICE is shown right after the grips of cyston1's #1 & #2 heads contacts the grips on cyston2's #2 & #1 heads respectfully. This action opens and closes appropriate valving within the appropriate heads, sparks the now compressed pf in chamber4, locks cyston1's grips to the clampcan within the housing (not shown) & cyston2's grips to the pushcan. At this point cyston2 is now a MOP cyston and cyston1 is SIP. Chamber1 will then be full of exhaust, Chamber2 will contains exhaust remains, chamber3 has fresh uncompressed pf and chamber4 will then be the powering chamber with the sparked and expanding pf moving cyston2 by pushing against it's #1 head.

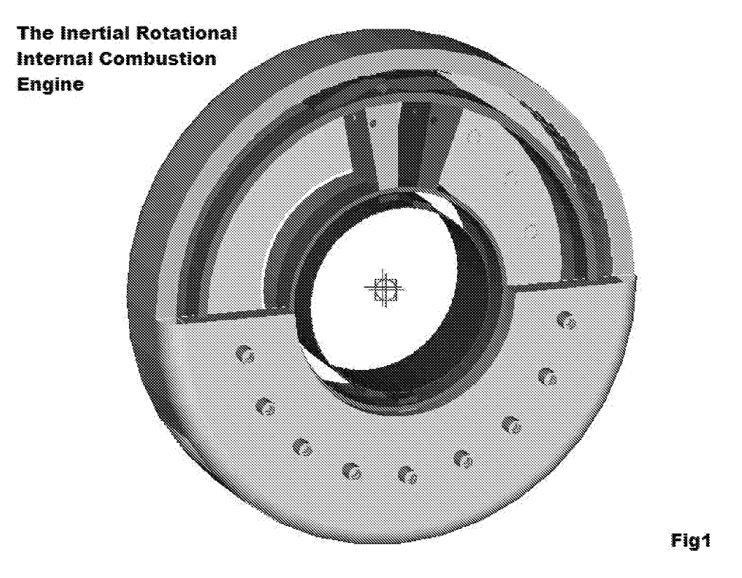

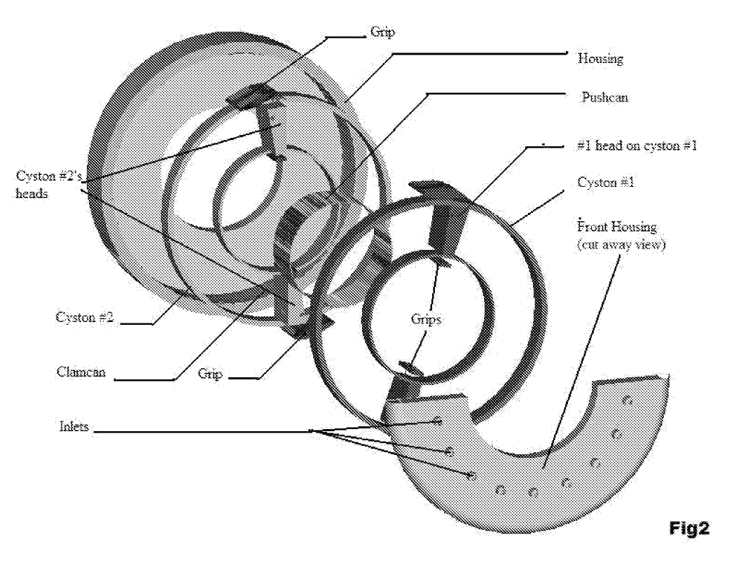

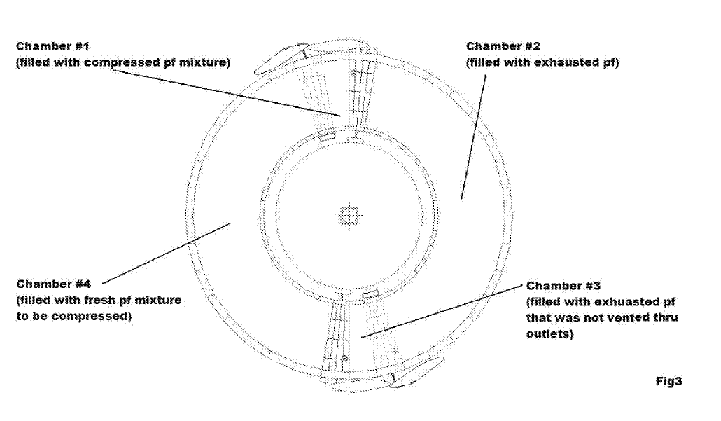

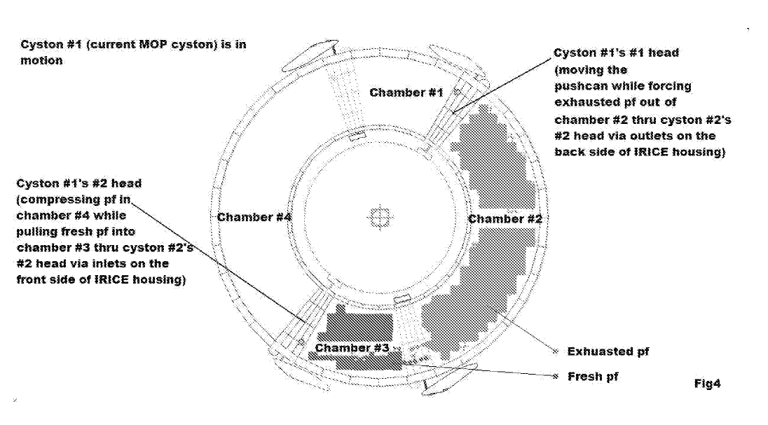

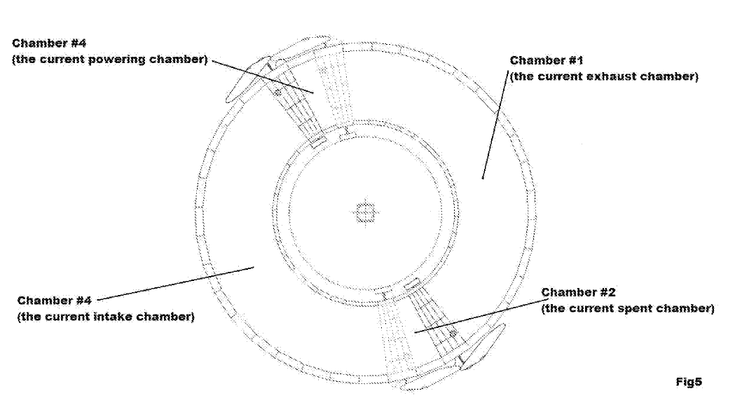

In this particular case of IRICE geometry, both cystons have now moved 160° each, moving the pushcan 320°. Thus by the time all chambers have fired, 1 cycle, the pushcan has been moved 640° (FIG. 7). In 9 cycles, the IRICE will return to where is was in FIGS. 1 & 3 but the cystons will have switched positions in the drawing. After 18 cycles, the pushcan will have turned 2880° (8 revolutions) and FIG. 3 will again be an exact representation of the current state of the IRICE.

### DESCRIPTION OF THE PREFERRED EMBODIMENT OF THE INVENTION

The IRICE engine can be used in a host of current and future applications. Although the inventor envisions this engine to primary serve as a more efficient mean of powering automobiles, it can also be used in any application where torque is used to do work or conventional power generators are needed. The inventor also believes that the IRICE engine can be used in such applications as, 2-wheeled drive motorcycles, in-wheel engines, free lane aerial roadsters and kinetic impulse deep space engines, to name a few. The inventor prefers that this invention be used in a way that both benefits the whole of mankind whilst simultaneously augmenting the inventor with profligacy.

What is claimed is:

1. The ‘Internal Rotation Inertial Cyston Engine’ (IRICE) consist of an engine housing having a closed volume, like a toroid, and with in it containing at least 2 cystons with at least one head per cyston, that form chambers between adjacent heads, that alternate in their respective relative states of motions from static (SIP) to moving (MOP) by locking against a relatively static section of said IRICE (clampcan) or a moving section of said IRICE (pushcan), respectively, there by transmitting the force produced via a fluid, gas, electromagnetic flux or combination of all or either of adequate force (pf) to move said adjacent MOP cyston head to preform work in the form of torque along said pushcan's axle of rotation.

2. The IRICE of claim 1 consist of adequate input (inlets), for the pf to enter the chamber of claim 1 between the two appropriate cyston heads which require it, and adequate output (outlets), for the used and/or expended pf to exit the IRICE's chambers, positioned individually and/or combined along any part or parts of the IRICE in a manner that allows them all to preform their respective duties in time.

3. The “locking” referred to in claim 1 is obtained by a means of gears, ratchets, fictional surfaces, magnetism and/or a combination of all or any of the hereto mentioned methods with the apparatus which locks to the Pushcan being called the Moving Grip (MG) and the apparatus which locks to the Clampcan being called Static Grip (SG) which may or may not be one in the same or separate devices.

4. The IRICE can have additional attached items to extend and improve on the function of the pushcan of claim 1 such as but not limited to:
(a) a flywheel to stabilize vibrations and/or allow the pushcan of claim 1 to continue outputting torque even when the IRICE's chamber are not firing.
(b) a power transfer mechanism to transmit torque to where the user of the IRICE needs it to be applied.
(c) fan blades or fins (sharksteeth) to move air for the purpose of cooling and/or thrust.
(d) Electrical circuitry to control any of the moving parts like switches, magnets, valves or devices to excite or ignite pf or wiring to create magnetic induction or current.
(e) Pumps and/or vacuums to move either coolant or pf throughout the IRICE as needed along with adequate piping to deliver it where it is needed.

5. The parts of claims 1, 2, 3 and 4 are of a size, shape and strength to allow for movement of all applicable parts from the pf of claim 1 without structural failure of any of said parts of the IRICE while yet limiting needless seepage of said pf through the contacting surfaces of any parts of the IRICE.
